(19) United States
(12) Patent Application Publication
(10) Pub. No.: US 2025/0239594 A1
(43) Pub. Date: Jul. 24, 2025

(54) COATED ACTIVE MATERIAL, ELECTRODE MIXTURE, BATTERY, AND PRODUCING METHOD

(71) Applicant: TOYOTA JIDOSHA KABUSHIKI KAISHA, Toyota-shi (JP)

(72) Inventor: Masaru KUBOTA, Okazaki-shi (JP)

(73) Assignee: TOYOTA JIDOSHA KABUSHIKI KAISHA, Toyota-shi (JP)

(21) Appl. No.: 19/018,978

(22) Filed: Jan. 13, 2025

(30) Foreign Application Priority Data
Jan. 22, 2024 (JP) 2024-007478

(51) Int. Cl. H01M 4/36; H01M 4/02; H01M 4/131; H01M 4/525; H01M 4/62; H01M 10/0562; H01M 10/0585; H01M 10/42

(52) U.S. Cl. CPC H01M 4/366; H01M 4/131; H01M 4/525; H01M 4/62; H01M 10/0562; H01M 10/0585; H01M 10/4235; H01M 2004/028; H01M 2300/008

(57) ABSTRACT

A coated active material, includes: an electrode active material; and a coating layer that covers the electrode active material and contains a coating material including a B element, a P element, and an O element, wherein: a moisture amount X generated in the coated active material in a temperature range of 120° C. or more and 180° C. or less is 10.0 ppm or less; and a coverage of the coating layer with respect to the electrode active material is larger than 67%.

### CROSS-REFERENCE TO RELATED APPLICATION

This application claims priority to Japanese Patent Application No. 2024-007478 filed on Jan. 22, 2024, incorporated herein by reference in its entirety.

### BACKGROUND

### 1. Technical Field

The present disclosure relates to a coated active material, an electrode mixture, a battery, and a method of producing a coated active material.

### 2. Description of Related Art

In recent years, batteries are under active development. For example, in automotive industries, development of batteries to be used in a battery electric vehicle (BEV), a plug-in hybrid electric vehicle (PHEV), or a hybrid electric vehicle (HEV) is promoted. Further, a technology of covering a surface of an electrode active material to be used in the battery with a phosphorus-based coat solution is known.

For example, Japanese Unexamined Patent Application Publication No. 2023-136753 discloses a composite particle including a positive electrode active material particle, and a coating film that covers at least a part of a surface of the positive electrode active material particle and includes a phosphorus compound. Further, JP 2023-136753 A discloses producing a composite particle by mixing a positive electrode active material particle and a water-based coating solution (water-based coat solution) containing phosphorus and drying the mixture.

### SUMMARY

In the coating method using the water-based coat solution containing phosphorus, even after sufficient drying, moisture remains in a coating layer. The remaining moisture may deteriorate the electrode active material or deteriorate an electrolyte present around the electrode active material to cause an increase in resistance.

In view of the foregoing, the inventors of the subject application have discussed covering the electrode active material with a coating material by a dry method. The use of the dry method allows a moisture amount of the coating layer to be reduced. Meanwhile, the inventors of the subject application have found a new problem that, in the case of the dry method, it is difficult to increase the coverage of the coating layer with respect to the electrode active material. When the coverage of the coating layer with respect to the electrode active material is low, the electrode active material and the electrolyte may react to generate a high resistance layer, and thus the increase in resistance may be caused.

The present disclosure provides a coated active material that reduces a resistance increase due to moisture and a resistance increase due to a high resistance layer.

A coated active material according to a first aspect of the present disclosure includes: an electrode active material; and a coating layer that covers the electrode active material and contains a coating material including a B element, a P element, and an O element, wherein: a moisture amount X generated in the coated active material in a temperature range of 120° C. or more and 180° C. or less is 10.0 ppm or less; and a coverage of the coating layer with respect to the electrode active material is larger than 67%.

In the coated active material according to the above-mentioned aspect, the moisture amount X may be 8.0 ppm or less.

In the coated active material according to the above-mentioned aspect, a moisture amount Y generated in the coated active material in a temperature range of 180° C. or more and 300° C. or less may be 350 ppm or less.

In the coated active material according to the above-mentioned aspect, the coverage may be 75% or more.

In the coated active material according to the above-mentioned aspect, the coating material may further include a Li element.

In the coated active material according to the above-mentioned aspect: the electrode active material may include a Li element, an M element, and an O element; M may be a metal other than Li and at least include Ni; and a molar ratio Ni/M of Ni to M may be 50% or more.

In the coated active material according to the above-mentioned aspect, Ni/M may be 80% or more.

In the coated active material according to the above-mentioned aspect, a BET specific surface area may be 0.50 m²/g or more and less than 1.20 m²/g.

An electrode mixture according to a second aspect of the present disclosure includes: the coated active material according to the above-mentioned aspect; and at least one of an electrically conductive material and a binder.

In the electrode mixture according to the above-mentioned aspect, the electrode mixture may include a solid electrolyte.

In the electrode mixture according to the above-mentioned aspect, the solid electrolyte may be a sulfide solid electrolyte.

A battery according to a third aspect of the present disclosure includes: a positive electrode layer; a negative electrode layer; and an electrolyte layer disposed between the positive electrode layer and the negative electrode layer, wherein the positive electrode layer or the negative electrode layer includes the electrode mixture of the above-mentioned aspect.

In the battery according to the above-mentioned aspect, the positive electrode layer may include the electrode mixture.

In the battery according to the above-mentioned aspect, the electrolyte layer may include a solid electrolyte.

A producing method of producing a coated active material of the above-mentioned aspect, according to a fourth aspect of the present disclosure, includes: preparing the electrode active material and the coating material; and forming the coating layer by covering the electrode active material with the coating material by a dry method, wherein a particle size D₉₀ of the coating material is 2 μm or less.

The coated active material in the present disclosure provides an effect of allowing the resistance increase due to moisture and the resistance increase due to the high resistance layer to be reduced.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic sectional view exemplifying a coated active material in the present disclosure;

FIG. 2 is a schematic sectional view exemplifying a battery in the present disclosure;

FIG. 3 is a flowchart exemplifying a method of producing a coated active material in the present disclosure; and

FIG. 4 is a graph showing resistances of the batteries produced in Examples 1 to 4 and Comparative Examples 1 to 7.

### DETAILED DESCRIPTION OF EMBODIMENTS

Hereinafter, a coated active material, an electrode mixture, a battery, and a method of producing a coated active material in the present disclosure are described in detail.

### A. Coated Active Material

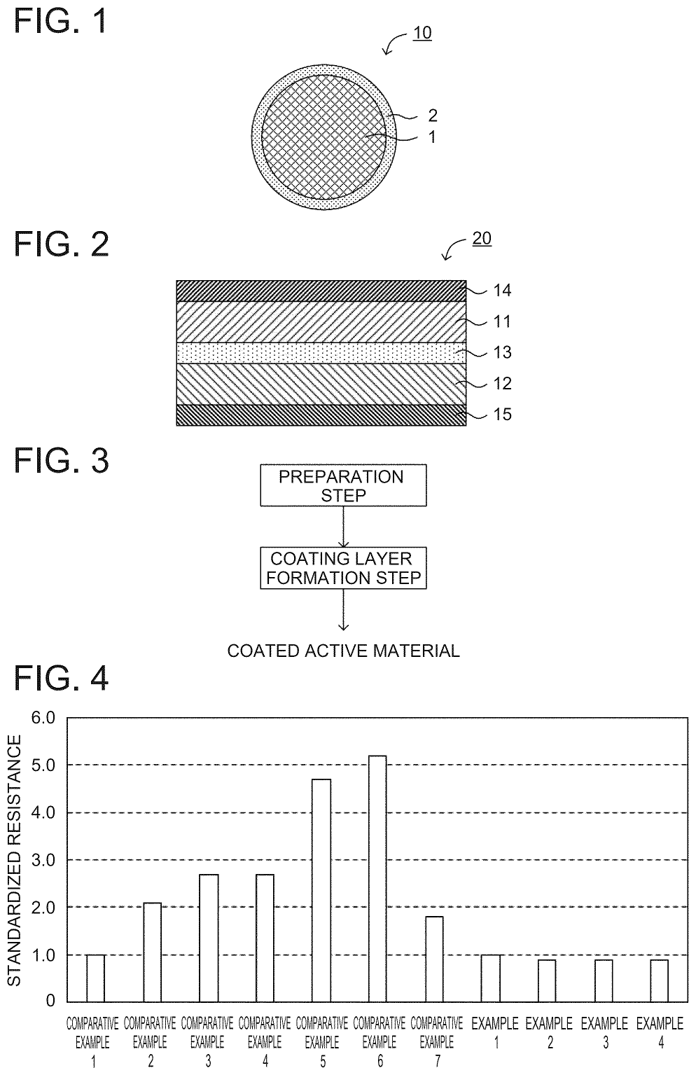

FIG. 1 is a schematic sectional view exemplifying the coated active material in the present disclosure. A coated active material 10 illustrated in FIG. 1 includes an electrode active material 1, and a coating layer 2 that covers the electrode active material 1 and contains a coating material including a B element, a P element, and an O element. In the coated active material 10, a moisture amount X generated in a temperature range of 120° C. or more and 180° C. or less is normally 10.0 ppm or less. Further, the coverage of the coating layer 2 with respect to the electrode active material 1 is normally larger than 67%.

According to the present disclosure, the moisture amount X is small and the coverage of the coating layer is high, and hence a coated active material that can reduce a resistance increase due to moisture and a resistance increase due to a high resistance layer is obtained. As described above, JP 2023-136753 A discloses producing a composite particle by mixing a positive electrode active material particle and a water-based coat solution containing phosphorus and drying the mixture. In the coating method using the water-based coat solution containing phosphorus, even after sufficient drying, moisture remains in a coating layer. The remaining moisture may deteriorate the electrode active material or deteriorate an electrolyte present around the electrode active material to cause an increase in resistance.

In view of the foregoing, the inventors of the subject application have discussed covering the electrode active material with a coating material by a dry method. When the dry method is used, there is no need to use a solvent such as water, and hence the moisture amount of the coating layer can be reduced. Meanwhile, the inventors of the subject application have found a new problem that, in the case of the dry method, it is difficult to increase the coverage of the coating layer with respect to the electrode active material. When the coverage of the coating layer with respect to the electrode active material is low, the electrode active material and the electrolyte may react to generate a high resistance layer, and thus the increase in resistance may be caused.

The inventors of the subject application have intensively studied to solve the above-mentioned new problem, and have found that the reason why it is difficult to increase the coverage is because the coating material containing phosphorus is hard, and the surface of the electrode active material is greatly damaged by the coating material when the electrode active material is covered with the coating material. In view of the foregoing, the inventors of the subject application have found that, when a fine coating material is used to reduce the damage of the surface of the electrode active material, the coverage of the coating material can be greatly improved. As a result, a coated active material having a small moisture amount and a high coverage of the coating layer can be obtained, and thus the resistance increase due to moisture and the resistance increase due to the high resistance layer can be simultaneously reduced. Further, the coating material includes the P element, and hence the chemical stability of the coating layer is improved. Moreover, the coating material includes the B element in addition to the P element, and hence the ionic conduction of the coating layer can be improved while the chemical stability of the coating layer is improved.

### 1. Coating Layer

The coating layer in the present disclosure is a layer that covers the electrode active material. Further, the coating layer contains the coating material including the B element, the P element, and the O element. The coating material may further include a Li element. Further, the coating material preferably has a PO₄ structure.

In the coating material, a molar ratio (B/P) of the B element to the P element is not particularly limited, but is, for example, 0.5 or more and 2.0 or less, and may be 0.8 or more and 1.25 or less or 0.9 or more and 1.11 or less. Further, when the coating material further includes the Li element, a molar ratio (Li/(P+B)) of the Li element to the sum of the P element and the B element is not particularly limited, but is, for example, 0.3 or more and 1.2 or less, and may be 0.5 or more and 1.0 or less.

The coverage of the coating layer with respect to the electrode active material is normally larger than 67%, and may be 75% or more or 80% or more. When the coverage is excessively low, it is difficult to sufficiently reduce the resistance increase due to the high resistance layer. Meanwhile, the coverage may be 100% or less than 100%. The coverage in the present disclosure is obtained by calculating an elemental ratio from intensity ratios of respective main elements based on X-ray photoelectron spectroscopy (XPS) measurement, and is obtained as a percentage of the elements included in the coating layer with respect to a sum of the elements included in the electrode active material and the elements included in the coating layer.

The thickness of the coating layer is not particularly limited, but is, for example, 1 nm or more and 100 nm or less, and may be 5 nm or more and 50 nm or less or 10 nm or more and 30 nm or less. The thickness of the coating layer is obtained as, for example, an average value of thicknesses of a plurality of samples (for example, 100 or more samples) observed by a scanning electron microscope (SEM) or a transmission electron microscope (TEM).

### 2. Electrode Active Material

The electrode active material in the present disclosure is not particularly limited, but preferably includes a Li element, an M element, and an O element. M is a metal other than Li (including a metalloid). M may be a transition metal, or may be a metal (including a metalloid) belonging to group 13 to group 16 in the periodic table. Further, M may be one type of metal or two or more types of metals. Of those, M is preferably at least one type among Ni, Co, Mn, Al, V, and Fe.

In particular, M preferably includes at least Ni. The electrode active material containing Ni is liable to deteriorate by moisture, but the coated active material in the present disclosure has a small moisture amount, and hence the deterioration of the electrode active material containing Ni can be reduced. A molar ratio (Ni/M) of Ni to M is not particularly limited, but is, for example, 30% or more, and may be 50% or more, 60% or more, 70% or more, or 80% or more. Meanwhile, Ni/M may be 100% or less than 100%.

The electrode active material may include, in addition to the Li element, the M element, and the O element, a nonmetal element such as a P element. Further, the crystal structure of the electrode active material is not particularly limited. Examples thereof include a layered rock-salt structure, a spinel structure, and an olivine structure.

As one example of the composition of the electrode active material, LiNiₓCo_{y}Al_{z}O₂ (0.5≤x, 0≤y, 0≤z, x+y+z=1) can be given. Symbol x may be 0.6 or more, 0.7 or more, or 0.8 or more. Symbol y may be 0 or larger than 0. Further, symbol y is, for example, 0.3 or less. Symbol z may be 0 or larger than 0. Further, symbol z is, for example, 0.1 or less.

As another example of the composition of the electrode active material, LiNiₐCo_{b}Mn_{c}O₂ (0.5≤a, 0≤b, 0≤c, a+b+c=1) can be given. Symbol a may be 0.6 or more, 0.7 or more, or 0.8 or more. Symbol b may be 0 or larger than 0. Further, symbol b is, for example, 0.3 or less. Symbol c may be 0 or larger than 0. Further, symbol c is, for example, 0.3 or less.

The shape of the electrode active material is normally a particulate shape. A particle size D₅₀ of the electrode active material is, for example, 100 nm or more, and may be 1 μm or more or 5 μm or more. Meanwhile, the particle size D₅₀ of the electrode active material is, for example, 50 μm or less, and may be 20 μm or less. In the present disclosure, the particle size D₅₀ corresponds to a particle size corresponding to cumulative 50% by volume measured by a laser diffraction particle size distribution measuring device.

### 3. Coated Active Material

In the coated active material in the present disclosure, a moisture amount X generated in a temperature range of 120° C. or more and 180° C. or less is normally 10.0 ppm or less. The moisture amount X may be 9.0 ppm or less or 8.0 ppm or less. A small moisture amount X can reduce the resistance increase due to moisture. Further, in the coated active material, a moisture amount Y generated in a temperature range of 180° C. or more and 300° C. or less is, for example, 350 ppm or less, and may be 320 ppm or less. A small moisture amount Y can reduce the resistance increase due to moisture. The method of measuring the moisture amount X and the moisture amount Y is as described in Examples later.

The BET specific surface area of the coated active material is not particularly limited, but is, for example, 0.50 m²/g or more, and may be 0.70 m²/g or more. Meanwhile, the BET specific surface area of the coated active material is, for example, less than 1.20 m²/g, and may be 1.00 m²/g or less.

The coated active material in the present disclosure is normally used in a battery. The electrode active material in the coated active material may be a positive electrode active material or a negative electrode active material, but the former is preferable. Examples of the method of producing the coated active material include a method described in “D. Method of Producing Coated Active Material” later.

### B. Electrode Mixture

An electrode mixture in the present disclosure includes the above-mentioned coated active material, and at least one of an electrically conductive material and a binder.

According to the present disclosure, the use of the above-mentioned coated active material allows an electrode mixture that can reduce the resistance increase due to moisture and the resistance increase due to the high resistance layer to be obtained.

The electrode mixture includes the coated active material, and at least one of the electrically conductive material and the binder. The coated active material is similar to the content described in “A. Coated Active Material” above. The electrode active material in the coated active material may be a positive electrode active material or a negative electrode active material, but the former is preferable. That is, the electrode mixture may be a positive electrode mixture or a negative electrode mixture, but the former is preferable.

A percentage of the coated active material in the electrode mixture is, for example, 20% by weight or more, and may be 30% by weight or more or 40% by weight or more. When the percentage of the coated active material is excessively small, a sufficient energy density may not be able to be obtained. Meanwhile, the percentage of the coated active material is, for example, 80% by weight or less, and may be 70% by weight or less or 60% by weight or less. When the percentage of the coated active material is excessively large, the ionic conduction and the electronic conduction in the electrode mixture may be relatively reduced.

The electrode mixture includes at least one of the electrically conductive material and the binder. Examples of the electrically conductive material include a carbon material, metal particles, and a conductive polymer. Examples of the carbon material include particulate carbon materials such as acetylene black (AB) and Ketjen black (KB) and fibrous carbon materials such as carbon fiber, carbon nanotube (CNT), and carbon nanofiber (CNF). Further, examples of the binder include a rubber-based binder and a fluorine-based binder.

The electrode mixture may further include a solid electrolyte. The solid electrolyte may be an organic solid electrolyte such as a gel electrolyte, or may be an inorganic solid electrolyte such as a sulfide solid electrolyte or an oxide solid electrolyte. Of those, the solid electrolyte is preferably a sulfide solid electrolyte. The reason therefor is because the ionic conduction is high.

The sulfide solid electrolyte normally at least contains a Li element and a S element. The sulfide solid electrolyte further preferably contains a Me element (Me is at least one type among P, As, Sb, Si, Ge, Sn, B, Al, Ga, and In). Further, the sulfide solid electrolyte may contain a halogen element such as F, Cl, Br, or I.

The sulfide solid electrolyte may be a glass-based (amorphous) sulfide solid electrolyte, a glass-ceramic-based sulfide solid electrolyte, or a crystalline sulfide solid electrolyte. The sulfide solid electrolyte may have a crystal phase. Examples of the above-mentioned crystal phase include a Thio-LISICON type crystal phase, an argyrodite type crystal phase, and an LGPS type crystal phase.

The composition of the sulfide solid electrolyte is not particularly limited, but examples thereof include xLi₂S·(1-x)P₂S₅ (0.5≤x<1) and yLiI·zLiBr(100-y-z)(xLi₂S·(1-x)P₂S₅) (0.5≤x<1, 0≤y≤30, 0≤z≤30). In those compositions, symbol x preferably satisfies 0.7≤x≤0.8. Further, as another example of the composition of the sulfide solid electrolyte, Li_{7-x-2y}PS_{6-x-y}X_{y} can be given. Symbol X indicates at least one type among F, Cl, Br, and I, and symbols x and y satisfy 0≤x and 0≤y. Further, as another example of the composition of the sulfide solid electrolyte, Li₄₋ₓMe₁₋ₓPₓS₄ (0<x<1) can be given. Me is at least one type among Al, Zn, In, Ge, Si, Sn, Sb, Ga, and Bi.

### C. Battery

FIG. 2 is a schematic sectional view exemplifying a battery in the present disclosure. A battery 20 illustrated in FIG. 2 includes a positive electrode layer 11, a negative electrode layer 12, an electrolyte layer 13 disposed between the positive electrode layer 11 and the negative electrode layer 12, a positive electrode current collector 14 that collects a current of the positive electrode layer 11, and a negative electrode current collector 15 that collects a current of the negative electrode layer 12. In the present disclosure, the positive electrode layer 11 or the negative electrode layer 12 includes the electrode mixture described in “B. Electrode Mixture” above.

According to the present disclosure, the use of the above-mentioned electrode mixture allows a battery that is reduced in the resistance increase due to moisture and the resistance increase due to the high resistance layer to be obtained. As described above, the electrode mixture may be a positive electrode mixture or a negative electrode mixture, but the former is preferable. Hereinafter, details of a battery in a case in which the electrode mixture is a positive electrode mixture are described.

### 1. Positive Electrode Layer

The positive electrode layer in the present disclosure includes the above-mentioned electrode mixture (positive electrode mixture). The electrode mixture is similar to the content described in “B. Electrode Mixture” above, and hence description thereof is omitted here. Further, the positive electrode layer may include an electrolyte as required. The electrolyte is similar to the content described in “3. Electrolyte Layer”. The thickness of the positive electrode layer is, for example, 0.1 μm or more and 1,000 μm or less, and may be 0.1 μm or more and 500 μm or less or 0.1 μm or more and 100 μm or less. Further, examples of the method of forming the positive electrode layer include a method of applying the electrode mixture (positive electrode mixture) to the positive electrode current collector.

### 2. Negative Electrode Layer

The negative electrode layer is a layer including at least a negative electrode active material. Further, the negative electrode layer may include at least one of an electrolyte, an electrically conductive material, and a binder as required.

Examples of the negative electrode active material include metal active materials such as Li and Sn, a Si-based active material, a carbon active material such as graphite, and an oxide active material such as Li₄Ti₅O₁₂.

The negative electrode active material is preferably a Si-based active material. The reason therefor is because the battery can be increased in capacity. The Si-based active material is an active material including Si as a main component. The Si-based active material may be Si alone, a Si alloy, or a Si oxide. Further, the Si-based active material may include a diamond type crystal phase, a type-I clathrate crystal phase, or a type-II clathrate crystal phase. In the crystal phase of the type-I clathrate or the type-II clathrate, a plurality of Si elements forms a polyhedron (cage) including pentagons or hexagons. This polyhedron has a space therein that can enclose Li ions, and hence the volume change in the charging and discharging can be reduced.

As the shape of the negative electrode active material, for example, a particulate shape can be given. The particle size D₅₀ of the negative electrode active material is not particularly limited, but is, for example, 10 nm or more, and may be 100 nm or more. Meanwhile, the particle size D₅₀ of the negative electrode active material is, for example, 50 μm or less, and may be 20 μm or less.

The electrolyte used in the negative electrode layer is similar to the content described in “3. Electrolyte Layer”. Further, the electrically conductive material and the binder used in the negative electrode layer are similar to the content described in “B. Electrode Mixture” above, and hence description thereof is omitted here. The thickness of the negative electrode layer is, for example, 0.1 μm or more and 1,000 μm or less, and may be 0.1 μm or more and 500 μm or less or 0.1 μm or more and 100 μm or less.

### 3. Electrolyte Layer

The electrolyte layer is a layer formed between the positive electrode layer and the negative electrode layer, and at least includes an electrolyte. The electrolyte may be a solid electrolyte or a liquid electrolyte (electrolyte solution).

The solid electrolyte is similar to the content described in “B. Electrode Mixture” above, and hence description thereof is omitted here. Meanwhile, the electrolyte solution preferably includes a supporting salt and a solvent. Examples of the supporting salt (lithium salt) of the electrolyte solution having a lithium ionic conduction include inorganic lithium salts such as LiPF₆, LiBF₄, LiClO₄, and LiAsF₆ and organic lithium salts such as LiCF₃SO₃, LiN(CF₃SO₂)₂, LiN(C₂F₅SO₂)₂, LiN(FSO₂)₂, and LiC(CF₃SO₂)₃. Examples of the solvent used in the electrolyte solution include cyclic esters (cyclic carbonates) such as ethylene carbonate (EC), propylene carbonate (PC), and butylene carbonate (BC) and linear esters (linear carbonates) such as dimethyl carbonate (DMC), diethyl carbonate (DEC), and ethyl methyl carbonate (EMC). The electrolyte solution preferably includes two or more types of solvents.

The thickness of the electrolyte layer is, for example, 0.1 μm or more and 1,000 μm or less, and may be 0.1 μm or more and 500 μm or less or 0.1 μm or more and 100 μm or less.

### 4. Other Configurations

The battery in the present disclosure preferably includes the positive electrode current collector that collects a current of the positive electrode layer, and the negative electrode current collector that collects a current of the negative electrode layer. Examples of the material of the positive electrode current collector include SUS, aluminum, nickel, iron, titanium, and carbon. Meanwhile, examples of the material of the negative electrode current collector include SUS, copper, nickel, and carbon.

The battery in the present disclosure may further include a restraining jig that applies a restraining pressure to the positive electrode layer, the electrolyte layer, and the negative electrode layer along a thickness direction thereof. In particular, when the electrolyte layer is a solid electrolyte layer, in order to form good ionic conduction path and electronic conduction path, a restraining pressure is preferably applied. The restraining pressure is, for example, 0.1 MPa or more, and may be 1 MPa or more or 5 MPa or more. Meanwhile, the restraining pressure is, for example, 100 MPa or less, and may be 50 MPa or less or 20 MPa or less.

### 5. Battery

The type of the battery in the present disclosure is not particularly limited, but is typically a lithium-ion battery. Further, the battery in the present disclosure may be a liquid battery including an electrolyte solution as the electrolyte layer, or may be a solid-state battery including a solid electrolyte layer as the electrolyte layer. The solid-state battery may be a semi-solid-state battery or an all-solid-state battery. Further, the battery in the present disclosure may be a primary battery or a secondary battery, but, of those, the secondary battery is preferable. The reason therefor is because the battery can be repeatedly charged and discharged, and can be effectively used as, for example, an on-vehicle battery.

Examples of the application of the battery include a power supply for a vehicle such as a hybrid electric vehicle (HEV), a plug-in hybrid electric vehicle (PHEV), a battery electric vehicle (BEV), a gasoline vehicle, or a diesel vehicle. In particular, the battery is preferably used for a power supply for drive of the hybrid electric vehicle (HEV), the plug-in hybrid electric vehicle (PHEV), or the battery electric vehicle (BEV). Further, the battery may be used as a power supply for a mobile object other than a vehicle (for example, a train, a ship, or an airplane), or may be used as a power supply for an electric product such as an information processing device.

### D. Method of Producing Coated Active Material

FIG. 3 is a flowchart exemplifying the method of producing the coated active material in the present disclosure. In the production method illustrated in FIG. 3, the electrode active material and the coating material are prepared (preparation step). Next, by a dry method, the electrode active material is covered with the coating material to form the coating layer (coating layer formation step). In the present disclosure, the covering condition is adjusted to obtain the coated active material described in “A. Coated Active Material” above. In particular, a coating material having a particle size D₉₀ of 2 μm or less is used.

According to the present disclosure, the use of a fine coating material allows a coated active material that can reduce the resistance increase due to moisture and the resistance increase due to the high resistance layer to be obtained.

### 1. Preparation Step

The preparation step in the present disclosure is a step of preparing the above-mentioned electrode active material and the above-mentioned coating material. The electrode active material and the coating material are similar to the content described in “A. Coated Active Material” above.

The shape of the coating material in the preparation step is normally a particulate shape. The particle size D₉₀ of the coating material is normally 2 μm or less, and may be 1 μm or less or 0.8 μm or less. The use of a fine coating material can prevent, when the electrode active material is covered with the coating material, the surface of the electrode active material from being damaged by the coating material. As a result, the coverage of the coating layer can be improved. Meanwhile, the particle size D₉₀ of the coating material is not particularly limited, but is, for example, 0.2 μm or more. The particle size D₉₀ corresponds to a particle size corresponding to cumulative 90% by volume from the smaller particle side measured by the laser diffraction particle size distribution measuring device.

The particle size D₅₀ of the coating material is, for example, 1 μm or less, and may be 0.6 μm or less or 0.4 μm or less. Meanwhile, the particle size D₅₀ of the coating material is not particularly limited, but is, for example, 0.1 μm or more. Further, a ratio of the particle size D₅₀ of the coating material to the particle size D₅₀ of the electrode active material is not particularly limited, but is, for example, 1% or more and 25% or less, and may be 5% or more and 15% or less.

The method of producing the coating material is not particularly limited. Examples thereof include a method including a synthesizing step of synthesizing a coarse material of the coating material, and a granulating step of granulating the above-mentioned coarse material. The synthesizing step is, for example, a step of dissolving a solute including a B source and a P source in a solvent to produce a coat solution, and then drying the coat solution.

The B source is not particularly limited as long as the B source is a simple substance or a compound including the B element, and examples thereof include a boric acid (H₃BO₃). The P source is not particularly limited as long as the P source is a simple substance or a compound including the P element, and examples thereof include an orthophosphoric acid (H₃PO₄) and a metaphosphoric acid (HPO₃). Further, the coat solution preferably includes an O source. Examples of the O source include an O element included in the above-mentioned B source or P source. Further, the above-mentioned solute may include a Li source. The Li source is not particularly limited as long as the Li source is a simple substance or a compound including the Li element, and examples thereof include lithium hydroxide (LiOH). Further, examples of the solvent include water.

As a specific example of the method of producing the coat solution, the following method of producing the coat solution can be given. First, a first aqueous solution obtained by dissolving an orthophosphoric acid (H₃PO₄) or a metaphosphoric acid (HPO₃) into water is produced. Next, a second aqueous solution obtained by dissolving a boric acid (H₃BO₃) into the first aqueous solution is produced. Next, lithium hydroxide monohydrate (LiOH·H₂O) is dissolved into the second aqueous solution. Further, the coat solution is dried so that a coarse material is obtained. The method of drying the coat solution is not particularly limited, but examples thereof include spray drying, an electric furnace, a vacuum drying oven, and a spray pyrolysis device.

The granulating step is a step of granulating the above-mentioned coarse material. Granulation of the coarse material allows a coating material having the particle size D₉₀ of 2 μm or less to be obtained. Examples of the method of granulating the coarse material include mechanical milling such as a bead mill and a ball mill. The mechanical milling may be performed in a dry condition or a wet condition. When the mechanical milling is performed in the wet condition, a solvent other than water is preferably used. The condition of the mechanical milling is not particularly limited, and is adjusted as appropriate so that the coating material having the particle size D₉₀ of 2 μm or less can be obtained.

### 2. Coating Layer Formation Step

The coating layer formation step in the present disclosure is a step of covering the above-mentioned electrode active material with the above-mentioned coating material by a dry method to form the above-mentioned coating layer.

Examples of the dry method include a method of subjecting a mixture including the electrode active material and the coating material to shearing treatment. The above-mentioned mixture does not basically include water, but may include a small amount of water to the extent that its influence is ignorable. The shearing treatment is, for example, treatment of rotating a chopper disposed in a container. As another example of the shearing treatment, there can be given a method of rotating a blade disposed in a container so that compression shear energy is applied to the mixture present between the blade and a wall surface of the container. Further, the condition of the shearing treatment is not particularly limited, and is adjusted as appropriate so that the coated active material described in “A. Coated Active Material” above can be obtained.

### 3. Coated Active Material

The coated active material obtained by the steps described above is similar to the content described in “A. Coating Material” above.

It is to be noted that the present disclosure is not limited to the above-mentioned embodiment. The above-mentioned embodiment is exemplary, and anything that has substantially the same configuration and produces similar actions and effects as a technical idea that is described in the claims of the present disclosure is included in the technical scope of the present disclosure.

### Comparative Example 1

### Production of Coat Solution

A metaphosphoric acid (produced by FUJIFILM Wako Pure Chemical Corporation) and deionized water were mixed at “Metaphosphoric acid:Ion-exchanged water”=4.52:191.8 (ratio by weight) to obtain an aqueous solution. A boric acid (produced by NACALAI TESQUE, INC.) was added and dissolved to the obtained aqueous solution such that the molar ratio (B/P) of the B element to the P element became 1.0. Moreover, lithium hydroxide monohydrate (produced by FUJIFILM Wako Pure Chemical Corporation) was added and dissolved such that the molar ratio (Li/(P+B)) of the Li element to the sum of the P element and the B element became 0.9. Thus, the coat solution was obtained.

### Production of Coated Active Material

Active material particles (LiNi_{0.81}Co_{0.15}Al_{0.04}O₂, particle size D₅₀=4.5 μm) were dispersed in the obtained coat solution to prepare a slurry. The solid concentration of the slurry was 69% by weight. Next, the slurry was dried with use of a spray drying device manufactured by BUCHI Corporation “product name: Mini Spray Dryer B-290” to form the coating layer on the surface of the active material particle. The drying air temperature of the spray drying device was 200° C., and the drying air flow rate was 0.45 m³/min. Next, the active material particle having the coating layer formed thereon was subjected to heat treatment under air atmosphere to obtain the coated active material. The heat treatment temperature was 200° C., and the heat treatment time was 5 hours.

### Comparative Example 2

### Production of Coating Material A

A coat solution was obtained similarly to Comparative Example 1. The obtained coat solution was dried with use of a spray drying device manufactured by BUCHI Corporation “product name: Mini Spray Dryer B-290” to obtain powder. The drying air temperature of the spray drying device was 200° C., and the drying air flow rate was 0.45 m³/min. After that, heat treatment was additionally performed under air atmosphere. The heat treatment temperature was 200° C., and the heat treatment time was 5 hours. Thus, a powder coating material A was obtained.

### Production of Coated Active Material

Into a mixing agitator BALANCE GRAN BG-2L (manufactured by FREUND-TURBO CORPORATION), 1,000 g of active material particles that are the same those of Comparative Example 1 and 31.0 g of the coating material A were fed. Next, agitating treatment was performed for 1 hour at the number of chopper rotations of 1,500 rpm to form the coating layer on the surface of the active material particle. Thus, the coated active material was obtained.

### Comparative Example 3

The coated active material was obtained similarly to Comparative Example 2 except that, when the coating layer was formed on the surface of the active material particle, agitating treatment was performed for 1 hour at each of the numbers of chopper rotations of 1,500 rpm and 2,000 rpm.

### Comparative Example 4

The coated active material was obtained similarly to Comparative Example 2 except that, when the coating layer was formed on the surface of the active material particle, agitating treatment was performed for 1 hour at each of the numbers of chopper rotations of 1,500 rpm, 2,000 rpm, and 2,500 rpm.

### Comparative Example 5

The coated active material was obtained similarly to Comparative Example 2 except that, when the coating layer was formed on the surface of the active material particle, agitating treatment was performed for 1 hour at each of the numbers of chopper rotations of 1,500 rpm, 2,000 rpm, 2,500 rpm, and 3,000 rpm.

### Comparative Example 6

The coated active material was obtained similarly to Comparative Example 2 except that, when the coating layer was formed on the surface of the active material particle, agitating treatment was performed for 1 hour at each of the numbers of chopper rotations of 1,500 rpm, 2,000 rpm, 2,500 rpm, 3,000 rpm, and 3,600 rpm.

### Comparative Example 7

### Production of Coating Material B

The coating material A was obtained similarly to Comparative Example 2. The coating material A was dispersed into ethanol such that the solid concentration became 20% by weight to obtain a dispersing liquid. A wet-type bead mill grinding device LABSTAR Mini MGF015 (manufactured by Ashizawa Finetech Ltd.) was prepared, and the obtained dispersing liquid was fed into a grinding chamber together with Zirconia balls (Φ0.1 mm) to perform grinding treatment for 90 minutes. The bead peripheral speed was 14 m/s, and the circulation flow rate was 0.3 L/min. Next, natural drying was performed for 24 hours in air atmosphere to volatilize ethanol. Moreover, vacuum drying was performed for 8 hours at 100° C. Thus, a coating material B was obtained.

### Production of Coated Active Material

Into the mixing agitator BALANCE GRAN BG-2L (manufactured by FREUND-TURBO CORPORATION), 1,000 g of active material particles that are the same as those of Comparative Example 1 and 31.0 g of the coating material B were fed. Next, agitating treatment was performed for 1 hour at the number of chopper rotations of 1,500 rpm to form the coating layer on the surface of the active material particle. Thus, the coated active material was obtained.

### Example 1

The coated active material was obtained similarly to Comparative Example 7 except that, when the coating layer was formed on the surface of the active material particle, agitating treatment was performed for 1 hour at each of the numbers of chopper rotations of 1,500 rpm and 2,000 rpm.

### Example 2

The coated active material was obtained similarly to Comparative Example 7 except that, when the coating layer was formed on the surface of the active material particle, agitating treatment was performed for 1 hour at each of the numbers of chopper rotations of 1,500 rpm, 2,000 rpm, and 2,500 rpm.

### Example 3

The coated active material was obtained similarly to Comparative Example 7 except that, when the coating layer was formed on the surface of the active material particle, agitating treatment was performed for 1 hour at each of the numbers of chopper rotations of 1,500 rpm, 2,000 rpm, 2,500 rpm, and 3,000 rpm.

### Example 4

The coated active material was obtained similarly to Comparative Example 7 except that, when the coating layer was formed on the surface of the active material particle, agitating treatment was performed for 1 hour at each of the numbers of chopper rotations of 1,500 rpm, 2,000 rpm, 2,500 rpm, 3,000 rpm, and 3,600 rpm. Table 1 shows the coating conditions of Examples 1 to 4 and Comparative Examples 1 to 7.

TABLE 1

| | Coating conditions | | |
|---|---|---|---|
| | | | Number of chopper |
| | Type | Material | rotations |
| Comparative | Wet | Coat solution | — |
| Example 1 | | | |
| Comparative | Dry | Coating material A | 1.5k |
| Example 2 | | | |
| Comparative | Dry | Coating material A | 1.5k, 2.0k |
| Example 3 | | | |
| Comparative | Dry | Coating material A | 1.5k, 2.0k, 2.5k |
| Example 4 | | | |
| Comparative | Dry | Coating material A | 1.5k, 2.0k, 2.5k, |
| Example 5 | | | 3.0k |
| Comparative | Dry | Coating material A | 1.5k, 2.0k, 2.5k, |
| Example 6 | | | 3.0k, 3.6k |
| Comparative | Dry | Coating material B | 1.5k |
| Example 7 | | | |
| Example 1 | Dry | Coating material B | 1.5k, 2.0k |
| Example 2 | Dry | Coating material B | 1.5k, 2.0k, 2.5k |
| Example 3 | Dry | Coating material B | 1.5k, 2.0k, 2.5k, |
| | | | 3.0k |
| Example 4 | Dry | Coating material B | 1.5k, 2.0k, 2.5k, |
| | | | 3.0k, 3.6k |

### Evaluation

### Particle Size Distribution Measurement

The particle size distributions of the coating material A and the coating material B were measured with use of the laser diffraction particle size distribution measuring device. As a result, the coating material A had the particle size D₅₀ of 2.3 μm and the particle size D₉₀ of 4.3 km. Meanwhile, the coating material B had the particle size D₅₀ of 0.34 μm and the particle size D₉₀ of 0.75 m.

### Measurement of Coverage

The coverage of the coated active material obtained in each of Examples 1 to 4 and Comparative Examples 1 to 7 was measured by X-ray photoelectron spectroscopy (XPS). Specifically, an X-ray photoelectron spectroscopy device (manufactured by ULVAC-PHI, Inc., PHIX-tool) was used to perform surface elemental analysis of the coated active material. Narrow scan analysis was performed with pass energy of 224 eV. After that, analysis software (MultiPak, manufactured by ULVAC-PHI, Inc.) was used to calculate an elemental ratio from the detected intensity values of C1s, O1s, P2p, Ni2p3, Co2p3, Al2p, and Bis, and the value of (P+B)/(P+B+Ni+Co+Al) [%] was obtained as the coverage. Table 2 shows the results.

### Measurement of BET Specific Surface Area

The BET specific surface area of the coated active material obtained in each of Examples 1 to 4 and Comparative Examples 1 to 7 was measured by a BET method. Specifically, BELSORP max II manufactured by Microtrac was used to perform N₂ adsorption BET specific surface area measurement. 5.0 g of the sample was weighed into a measuring tube under nitrogen atmosphere, and was subjected to vacuum degassing at room temperature for 8 hours under connection to the measuring device. After that, measurement was carried out at least at 10 points within a relative pressure P/P₀ of from 0.250 to 0.995 to calculate the BET specific surface area. Table 2 shows the results.

### Measurement of Moisture Amount

The moisture amount of the coated active material obtained in each of Examples 1 to 4 and Comparative Examples 1 and 7 was measured by a Karl-Fischer method. Specifically, MKC-710 series manufactured by KYOTO ELECTRONICS MANUFACTURING CO., LTD. was used to measure a minute moisture amount in the sample. Into a sample container, 1.0 g of the coated active material was fed under nitrogen atmosphere, and then the sample container was set to the device. After blank measurement at 120° C., the temperature was kept at 120° C., and the moisture was detected until the minimum electrolytic volume became 0.1 g or less. After that, the temperature was raised to 180° C. and similar operation was performed, and the moisture was detected until the minimum electrolytic volume became 0.1 g or less. Next, the temperature was raised to 300° C. and similar operation was repeated. Thus, the moisture generation amount in each temperature range was measured, and was divided by the sample weight for conversion into the moisture amount (unit of ppm). Table 2 shows the results.

### Resistance Measurement

The coated active material obtained in each of Examples 1 to 4 and Comparative Examples 1 to 7 was used as the positive electrode active material to produce a battery, and a resistance thereof was measured.

First, a positive electrode active material (coated active material), a sulfide solid electrolyte (10LiI-15LiBr-75Li₃PS₄), an electrically conductive material (VGCF), a binder (SBR), and a dispersion medium (heptane) were mixed to prepare a positive electrode slurry. A mixing ratio of the positive electrode active material and the sulfide solid electrolyte was “Positive electrode active material:Sulfide solid electrolyte”=6:4 (ratio by volume). 3 parts by mass of the electrically conductive material and 3 parts by mass of the binder were added per 100 parts by weight of the positive electrode active material. The positive electrode slurry was sufficiently agitated by an ultrasonic homogenizer, and the positive electrode slurry was applied to the surface of the positive electrode current collector (Al foil) to form a coating film. The coating film was dried on a hot plate at 100° C. for 30 minutes. Thus, apositive electrode web was obtained. A disk-shaped positive electrode was cut out from the positive electrode web. The positive electrode had an area of 1 cm².

Next, the negative electrode and the solid electrolyte layer were prepared. The negative electrode active material was graphite. The positive electrode, the solid electrolyte layer, and the negative electrode used the same type of sulfide solid electrolyte therebetween. In a cylindrical jig, the positive electrode, the solid electrolyte layer, and the negative electrode were stacked in the stated order to form a stack. The stack was pressed to form a power generation element. The power generation element was connected to terminals to obtain a battery (all-solid-state battery). An open circuit voltage (OCV) of the obtained all-solid-state battery was adjusted to 2.03 V, and then constant current discharge was performed. Further, the voltage drop in 5 seconds was divided by the current amount to measure the battery resistance. The discharge current rate was 2.5 C. The resistance of the battery of Comparative Example 1 was used as a reference (1.0) to relatively evaluate the resistance of the battery of each Example and each Comparative Example. Table 2 and FIG. 4 show the results.

TABLE 2

| | | BET specific | | | |
|---|---|---|---|---|---|
| | Coverage | surface area | Moisture amount [ppm] | | Standardized |
| | [%] | [m²/g] | 120° C.-180° C. | 180° C.-300° C. | resistance |
| Comparative | 96 | 0.97 | 38.4 | 409.3 | 1.0 |
| Example 1 | | | | | |
| Comparative | 65 | 1.33 | — | — | 2.1 |
| Example 2 | | | | | |
| Comparative | 56 | 1.43 | — | — | 2.7 |
| Example 3 | | | | | |
| Comparative | 55 | 1.28 | — | — | 2.7 |
| Example 4 | | | | | |
| Comparative | 42 | 1.27 | — | — | 4.7 |
| Example 5 | | | | | |
| Comparative | 67 | 1.2 | — | — | 5.2 |
| Example 6 | | | | | |
| Comparative | 53 | 1.53 | 8.8 | 319 | 1.8 |
| Example 7 | | | | | |
| Example 1 | 84 | 1.15 | 6.6 | 311 | 1.0 |
| Example 2 | 80 | 0.99 | 7.8 | 282 | 0.9 |
| Example 3 | 86 | 1 | 1.8 | 292 | 0.9 |
| Example 4 | 93 | 0.95 | 9.8 | 229 | 0.9 |

As shown in Table 2, Comparative Example 1 used the wet method, and hence it was confirmed that the moisture amount was relatively high even after drying. In contrast, Examples 1 to 4 used the dry method, and hence it was confirmed that the moisture amount was low. Further, as shown in Table 2 and FIG. 4, when Example 1 and Comparative Example 1 were compared, the coverage (84%) of Example 1 was lower than the coverage (96%) of Comparative Example 1, and Example 1 had a situation in which the resistance increase due to the high resistance layer was liable to occur, but the moisture amount of Example 1 was lower than the moisture amount of Comparative Example 1, and thus Example 1 was able to reduce the resistance increase due to moisture. As a result, the resistance was in the same level. Further, Examples 2 to 4 had a resistance lower than Example 1. Examples 1 to 4 used no organic solvent, and thus were advantageous in terms of low cost and environmental load reduction.

Meanwhile, as shown in Table 2, when Comparative Examples 2 to 6 and Examples 1 to 4 were compared, it was confirmed that the coverage was greatly improved with use of the granulated coating material B. Further, as shown in Table 2 and FIG. 4, Comparative Examples 2 to 6 used the dry method and thus had a low moisture amount, but had a low coverage, and it is inferred that the resistance increase due to the high resistance layer thus occurred. Meanwhile, although Comparative Example 7 used the dry method and thus had a low moisture amount and also used the granulated coating material B, the coverage was low because the coating treatment was insufficient. It is inferred that the resistance increase due to the high resistance layer thus occurred. In contrast, Examples 1 to 4 used the dry method and thus had a low moisture amount and also used the granulated coating material B, and sufficient coating treatment was performed. Thus, the coverage was able to be increased. It is considered that, as a result, the resistance increase due to moisture and the resistance increase due to the high resistance layer were able to be reduced.

Further, regarding the BET specific surface area, as shown in Table 2, in Comparative Examples 2 to 6 using the coating material A, the BET specific surface areas of the coated active materials were substantially the same. This supports the fact that the coverage is not improved along with the agitating treatment. Meanwhile, in Comparative Example 7 and Examples 1 to 4 using the coating material B, the coverage was improved as the agitating treatment time extended, and the value reduced down to the BET specific surface area equivalent to Comparative Example 1 (wet method). This indicates that the coverage improved along with the agitating treatment by spreading the coating material B on the surface of the active material.

What is claimed is:

1. A coated active material, comprising:
an electrode active material; and
a coating layer that covers the electrode active material and contains a coating material including a B element, a P element, and an O element, wherein:
a moisture amount X generated in the coated active material in a temperature range of 120° C. or more and 180° C. or less is 10.0 ppm or less; and
a coverage of the coating layer with respect to the electrode active material is larger than 67%.

2. The coated active material according to claim 1, wherein the moisture amount X is 8.0 ppm or less.

3. The coated active material according to claim 1, wherein a moisture amount Y generated in the coated active material in a temperature range of 180° C. or more and 300° C. or less is 350 ppm or less.

4. The coated active material according to claim 1, wherein the coverage is 75% or more.

5. The coated active material according to claim 1, wherein the coating material further includes a Li element.

6. The coated active material according to claim 1, wherein:
the electrode active material includes a Li element, an M element, and an O element;
M is a metal other than Li and at least includes Ni; and
a molar ratio Ni/M of Ni to M is 50% or more.

7. The coated active material according to claim 6, wherein Ni/M is 80% or more.

8. The coated active material according to claim 1, wherein a BET specific surface area is 0.50 m²/g or more and less than 1.20 m²/g.

9. An electrode mixture, comprising:
the coated active material according to claim 1; and
at least one of an electrically conductive material and a binder.

10. The electrode mixture according to claim 9, wherein the electrode mixture includes a solid electrolyte.

11. The electrode mixture according to claim 10, wherein the solid electrolyte is a sulfide solid electrolyte.

12. A battery comprising:
a positive electrode layer;
a negative electrode layer; and
an electrolyte layer disposed between the positive electrode layer and the negative electrode layer,
wherein the positive electrode layer or the negative electrode layer includes the electrode mixture of claim 9.

13. The battery according to claim 12, wherein the positive electrode layer includes the electrode mixture.

14. The battery according to claim 12, wherein the electrolyte layer includes a solid electrolyte.

15. A producing method of producing the coated active material of claim 1, the method comprising:
preparing the electrode active material and the coating material; and
forming the coating layer by covering the electrode active material with the coating material by a dry method,
wherein a particle size D₉₀ of the coating material is 2 μm or less.
